(19) United States
(12) Patent Application Publication
(10) Pub. No.: US 2008/0107113 A1
(43) Pub. Date: May 8, 2008

(54) Set/Reset Mechanism

(75) Inventor: Menzo Wentink, Utreacht (NL)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONEXANT SYSTEMS, INC., Red Bank, NJ (US)

(21) Appl. No.: 11/930,715

(22) Filed: Oct. 31, 2007

Related U.S. Application Data
(60) Provisional application No. 60/857,239, filed on Nov. 7, 2006.

(51) Int. Cl. H04L 12/56

(52) U.S. Cl. 370/392

(57) ABSTRACT

Included are embodiments for resetting a signal. At least one embodiment of a method includes sending a first packet, the first packet including a first legacy physical layer header, the first legacy physical layer header including a first duration indication configured to indicate a predetermined duration, the predetermined duration being longer than an expected time for a second packet and sending the second packet prior to expiration of the first duration indication, the second packet including a second legacy physical layer header, the second legacy physical layer header configured to provide a second duration indication substantially equal to a length of the second packet.

### CROSS REFERENCE

This application claims the benefit of U.S. Provisional No. 60/857,239, filed Nov. 7, 2006, which is hereby incorporated by reference in its entirety.

### BACKGROUND

With the emergence of wireless communications, a plurality of wireless protocols such as Wireless Fidelity (WIFI), Session Initiation Protocol (SIP), Worldwide Interoperability for Microwave Access (WiMAX), etc. have emerged. Utilization of one or more of the wireless protocols have provided users with the ability to communicate with other users, computers, etc. without the constraints of a wired connection. To further facilitate mobility, many communications devices also utilize wireless power sources, such as batteries. As many of these wireless communications devices utilize battery power, conserving power to extend battery life has emerged as a priority.

As such, many communications devices are configured to enter a power save mode, during which time the communications device may shut down one or more components, thereby conserving power. While utilization of this power save mode may provide power conservation, problems may arise in determining when the communication device should resume normal operation and/or when the communication device should enter the power save mode.

### SUMMARY

Included are embodiments for resetting a signal. At least one embodiment of a method includes sending a first packet, the first packet including a first legacy physical layer header, the first legacy physical layer header including a first duration indication configured to indicate a predetermined duration, the predetermined duration being longer than an expected time for a second packet and sending the second packet prior to expiration of the first duration indication, the second packet including a second legacy physical layer header, the second legacy physical layer header configured to provide a second duration indication substantially equal to a length of the second packet.

Also included are embodiments of a system. At least one embodiment includes a first sending component configured to send a first packet, the first packet including a first legacy physical layer header, the first legacy physical layer header including a first duration indication configured to indicate a predetermined duration, the predetermined duration being longer than an expected time for a second packet and a second sending component configured to send the second packet, the second packet including a second legacy physical layer header, the second legacy physical layer header configured to provide a second duration indication substantially equal to a length of the second packet, the second legacy physical layer header further configured to reset an indication by the first legacy physical layer header.

Also included are embodiments of a computer readable medium. At least one embodiment includes first sending logic configured to send a first packet, the first packet including a first legacy physical layer header, the first legacy physical layer header including a first duration indication configured to indicate a predetermined duration, the predetermined duration being longer than an expected time for a second packet and second sending logic configured to send the second packet, the second packet including a second legacy physical layer header, the second legacy physical layer header configured to provide a second duration indication substantially equal to a length of the second packet, the second legacy physical layer header further configured to reset an indication by the first legacy physical layer header.

Other systems, methods, features, and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

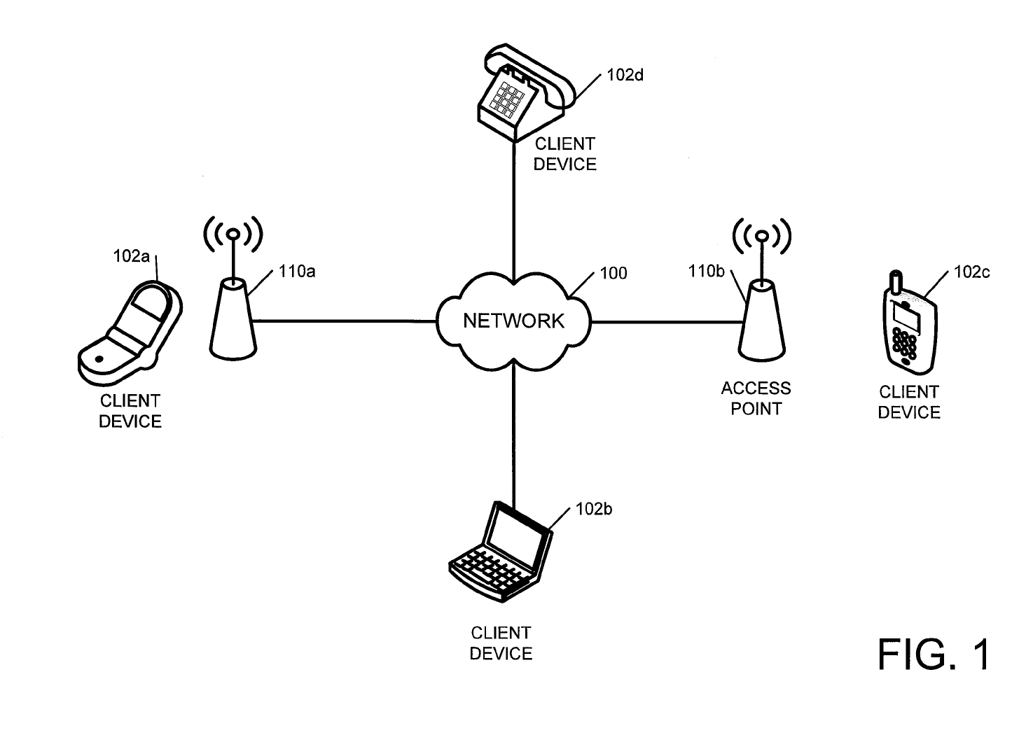

FIG. 1 depicts a diagram illustrating an exemplary embodiment of a network configuration that may be utilized for wireless communications.

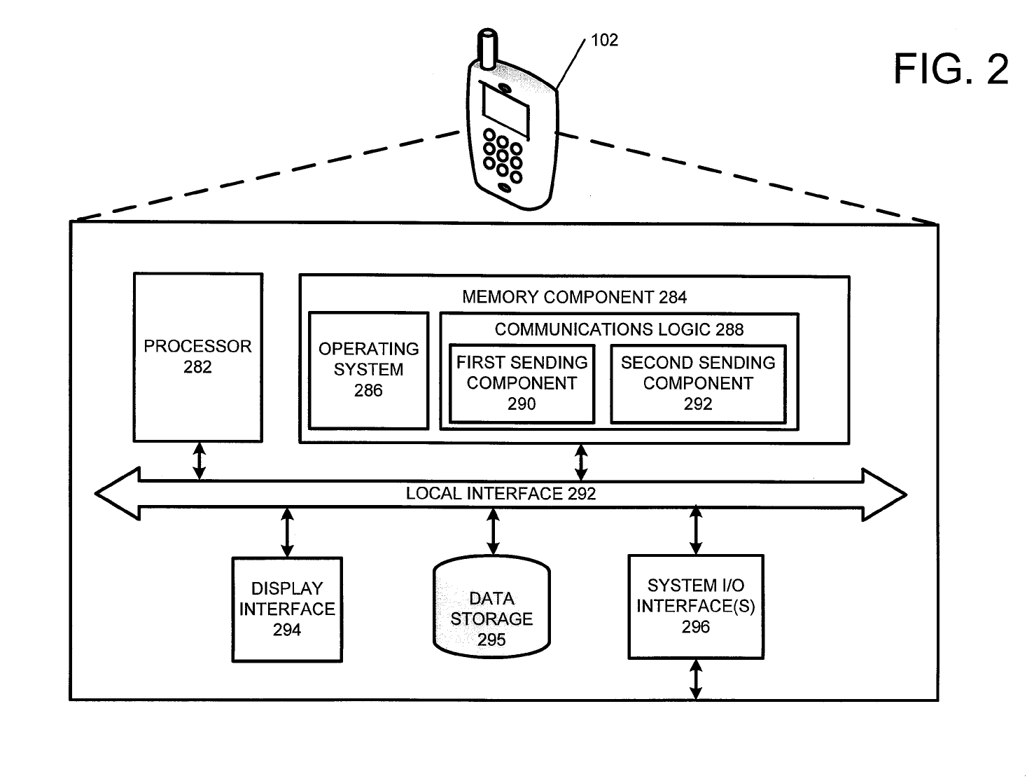

FIG. 2 depicts a functional block diagram illustrating a communications device, similar to the communications device from FIG. 1.

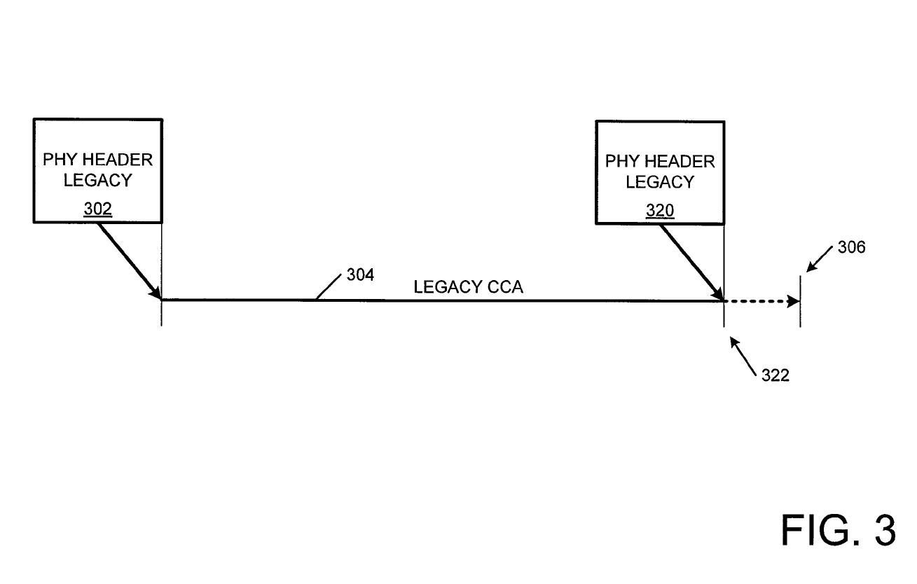

FIG. 3 depicts a block diagram illustrating an exemplary embodiment of utilizing a PHY legacy header to reset a previously sent PHY legacy header, such as in the network from FIG. 1.

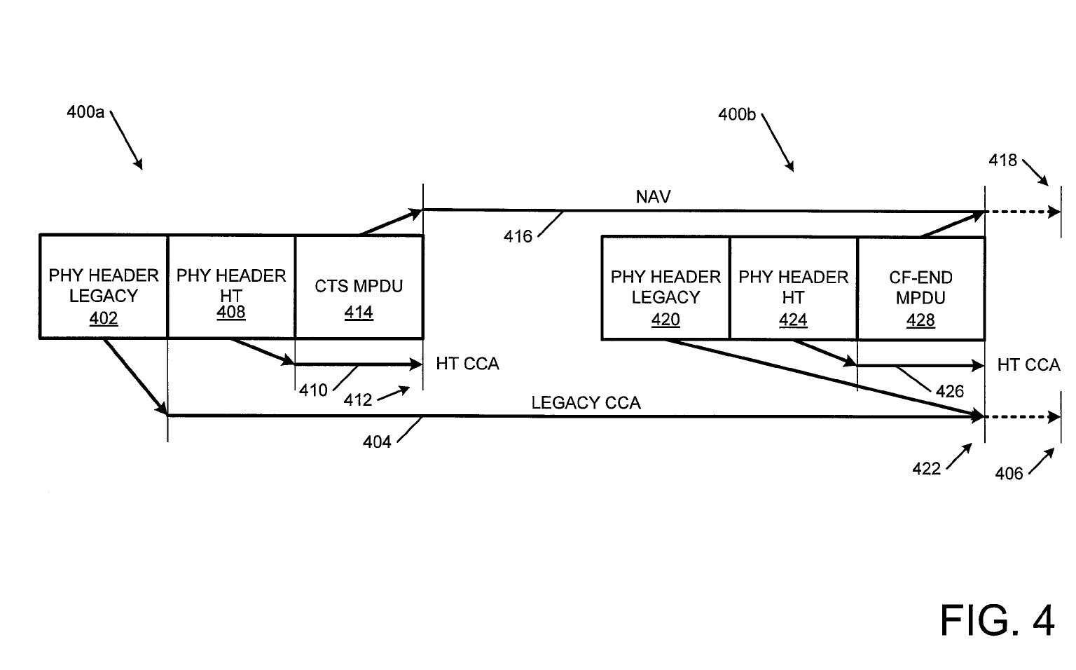

FIG. 4 depicts an exemplary embodiment of sending a PHY legacy header and a PHY high throughput (HT) header, similar to the diagram from FIG. 3.

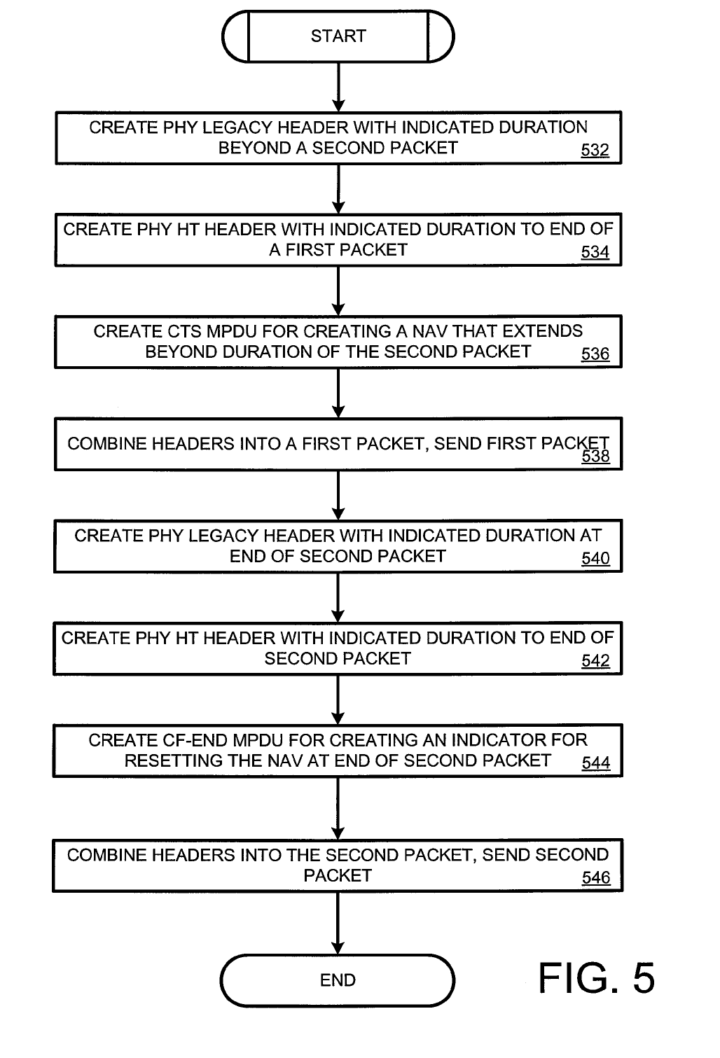

FIG. 5 depicts an exemplary embodiment of a process that may be utilized in sending data, similar to the diagram from FIG. 4.

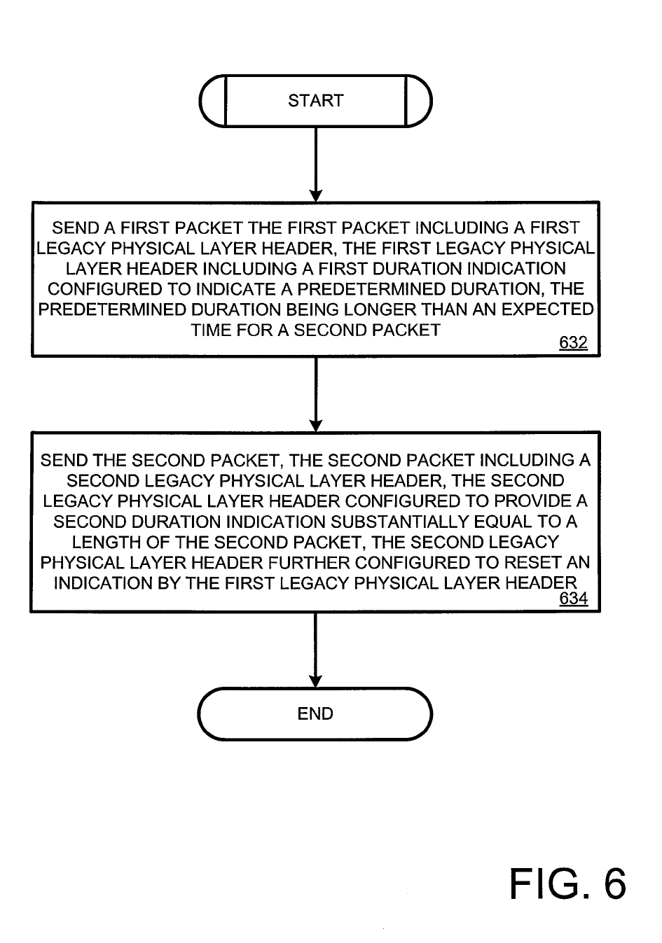

FIG. 6 depicts an exemplary embodiment of a process that may be utilized in sending data in a communications network, similar to the diagram from FIG. 5.

### DETAILED DESCRIPTION

The Carrier Sense Set and Reset Mechanism is a mechanism that may be configured to utilize IEEE 802.11 physical layer (PHY) headers to set a clear channel assessment (CCA) for a duration that may extend the actual transmit opportunity duration, and a second PHY header to reset this CCA once the transmit opportunity has finished. The first PHY header may be configured to encode the duration through a combination of PHY rate and a media access control (MAC) protocol data unit (MPDU) size. Depending on the particular configuration, there does not need to be an actual MPDU attached to the PHY header. A CCA reset to the PHY header may contain an MPDU size of 0, or a relatively short MPDU size, so that the CCA is effectively truncated.

In at least one embodiment, the first PHY header, which sets the CCA, may be combined with a clear to send (CTS) frame, which is used to distribute a MAC duration. This may result in a virtual carrier sense or a network allocation vector (NAV) being activated by receivers of the frame. By setting a transmit opportunity CCA and a transmit opportunity NAV at the same time one embodiment may include the Mixed Mode PHY headers as defined in 802.11n draft 1.0, because this is the only PHY header includes both a legacy signal field which can be used to convey a CCA that is longer than an associated physical layer protocol data unit (PPDU), and a high throughput (HT) signal field, which may be used to designate the actual duration of the PPDU.

The MPDU size of the CCA reset frame may also cover a contention free end (CF-End) frame, which has a similar CCA reset function but then for resetting a network allocation vector (NAV). In this way, the CF-End transmission truncates both the PHY and MAC layer carrier sense.

FIG. 1 depicts a diagram illustrating an exemplary embodiment of a network configuration that may be utilized for wireless communications. As illustrated in the nonlimiting example from FIG. 1, network 100 may be coupled to access points 110a and 110b. Access points 110a and 110b can be configured to provide wireless communications to communications devices 102a, 102b, 102c and/or 102d. More specifically, depending on the particular configuration, access points 110a and/or 110b may be configured for providing Voice Over Internet Protocol (VoIP) services, WI-FI services, WiMAX services, wireless SIP services, Bluetooth services and/or other wireless communication services.

The network 100 may include a Public Switched Telephone Network (PSTN), a Voice over Internet Protocol (VoIP) network, an Integrated Services Digital Network (ISDN), the Internet, a cellular network, and/or other mediums for communicating data between communication devices. More specifically, while the communications devices 102a and 102b may be configured for WI-FI communications, communications devices 102c and 102d may be coupled to the network 100 and may be configured for VoIP communications, Bluetooth communications, WI-FI communications, and/or other wireline and/or wireless communications.

FIG. 2 depicts a functional block diagram illustrating a communications device, similar to the communications device from FIG. 1. As illustrated in FIG. 2, in terms of hardware architecture, the communications device 102 may include a processor 282, a memory component 284, a display interface 294, a data storage component 295, and one or more input and/or output (I/O) device interface(s) 296 that are communicatively coupled via a local interface 292. The local interface 292 can include, for example but not limited to, one or more buses and/or other wired or wireless connections. The local interface 292 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 282 may be a hardware device for executing software, particularly software stored in the memory component 284.

The processor 282 can be any custom made or commercially available processor, a central processing unit (CPU), an auxiliary processor among several processors associated with the computing device 104, a semiconductor based microprocessor (in the form of a microchip or chip set), a macroprocessor, or generally any device for executing instructions.

The memory component 284 can include any one or combination of volatile memory elements (e.g., random access memory (RAM, such as DRAM, SRAM, SDRAM, VRAM, etc.)) and nonvolatile memory elements (e.g., ROM, hard drive, tape, CD-ROM, etc.). Moreover, the memory component 284 may incorporate electronic, magnetic, optical, and/or other types of storage media. Note that the memory component 284 can also have a distributed architecture, where various components are situated remotely from one another, but can be accessed by the processor 282.

The software in the memory component 284 may include one or more separate programs, each of which includes an ordered listing of executable instructions for implementing logical functions. In the example of FIG. 2, the software in the memory component 284 may include communications logic 288, as well as an operating system 286, and a recording cache 297. As illustrated, the communications logic 288 may include a first sending component 290 configured to send a first packet, the first packet including a first legacy physical layer header, the first legacy physical layer header including a duration indication configured to indicate a predetermined duration, the predetermined duration being longer than an expected time for a second packet. Similarly, the communications logic 288 may include a second sending component 292 configured to send the second packet, the second packet including a second legacy physical layer header, the second legacy physical layer header configured to indicate a duration substantially equal to a length of the second packet, the second legacy physical layer header further configured to reset an indication by the first legacy physical layer header. Other components may also be included.

Additionally, while the logic components 286 and 288 are each illustrated in this nonlimiting example as a single piece of logic, these components can include one or more separate software, hardware, and/or firmware modules. Similarly, one or more of these logical components can be combined to provide the desired functionality. Additionally, the operating system 286 may be configured to control the execution of other computer programs and may be configured to provide scheduling, input-output control, file and data management, memory management, and communication control and related services.

A system component embodied as software may also be construed as a source program, executable program (object code), script, and/or any other entity comprising a set of instructions to be performed. When constructed as a source program, the program is translated via a compiler, assembler, interpreter, or the like, which may or may not be included within the volatile and nonvolatile memory 284, so as to operate properly in connection with the Operating System 286.

The Input/Output devices that may be coupled to system I/O Interface(s) 296 may include input devices, for example but not limited to, a keyboard, mouse, scanner, microphone, camera, proximity device, receiver, etc. Further, the Input/Output devices may also include output devices, for example but not limited to, a printer, display, transmitter, etc. The Input/Output devices may further include devices that communicate both as inputs and outputs, for instance but not limited to, a modulator/demodulator (modem for accessing another device, system, or network), a radio frequency (RF) or other transceiver, a telephonic interface, a bridge, a router, etc. Similarly, network interface 294, which is coupled to local interface 292, can be configured to communication with a communications network, such as the network from FIG. 1. While this communication may be facilitated via the communications device 102, this is not a requirement.

If the communications device 102 is a personal computer, workstation, or the like, the software in the memory component 284 may further include a basic input output system (BIOS) (omitted for simplicity). The BIOS is a set of software routines that initialize and test hardware at startup, start the Operating System 286, and support the transfer of data among the hardware devices. The BIOS is stored in ROM so that the BIOS can be executed when the access point 110 is activated.

When the communications device 102 is in operation, the processor 282 can be configured to execute software stored within the memory component 284, to communicate data to with the memory component 284, and to generally control operations of the communications device 102 pursuant to the software. Software in memory 284, in whole or in part, may be read by the processor 282, perhaps buffered within the processor 282, and then executed. Additionally, one should note that while the above description is directed to a communications device 102, other devices can also include the components described in FIG. 2.

One should note that the access point 110 (which may also be seen as a communications device) can be configured with one or more of the components and/or logic described above with respect to the communications device 102. Additionally, the access point 110, the communications device 102, and/or other components of FIG. 1 can include voice recognition logic, voice-to-text logic, text-to-voice logic, etc. (or any permutation thereof), as well as other components and/or logic for facilitating the operations described herein.

FIG. 3 depicts a block diagram illustrating an exemplary embodiment of utilizing a PHY legacy header to reset a previously sent PHY legacy header, such as in the network from FIG. 1. As illustrated in the nonlimiting example of FIG. 3, the communications device 102 may send a first PHY legacy header 302. The PHY legacy header 302 may be configured to indicate, via a legacy CCA 304, a duration for sending data.

More specifically, the communications device 102 may include the PHY legacy header 302 as a part of a MAC header, which defines the legacy CCA 304 up to a duration (indicated at line 306) beyond that which is needed for transmission and/or receipt of a response (indicated by line 322). During the pendency of the legacy CCA 304, however, the communications device 102 can send another PHY legacy header 320 that indicates a duration only to the end of that frame (indicated by line 332). The PHY legacy header 320 will be received by the access point 110, which will conclude that, since another PHY legacy header 320 is received, more data is coming and will terminate the legacy CCA 304 and the end of the second PHY legacy header 320.

FIG. 4 depicts an exemplary embodiment of sending a PHY legacy header 402 and a PHY high throughput (HT) header 408, similar to the diagram from FIG. 3. As illustrated in the nonlimiting example of FIG. 4, the communications device 102 can send a first packet 400a, which may include the PHY legacy header 402, the PHY HT header 408, and a clear to send (CTS) Media Access Control (MAC) Protocol Data Unit (MPDU) 414. The PHY legacy header 402 may be configured to set a legacy CCA 404, which has a predetermined duration, as indicated by line indicator 406. In at least one embodiment, the duration of the legacy CCA 404 is configured to extend beyond the duration of a second packet 400b. Also included in the first packet 400a is a PHY HT header 408, which is configured to indicate the duration of the first packet 400a, as indicated by an HT CCA 410 and a line indicator 412. Also included in the packet 400a is a CTS MPDU 414. The CTS MPDU may be configured to send a network allocation vector (NAV) 416. Similar to the legacy CCA 404, the NAV 416 may define a predetermined duration beyond the duration of the next packet 400b.

Additionally, the communications device 102 may be configured to send the second packet 400b, which may include a second PHY legacy header 420, a second HT header 424, and a CF-End MPDU 428. The second PHY legacy header 420 may be configured to indicate a predetermined duration of the second packet 400b for terminating the legacy CCA, as discussed with regard to FIG. 3. Similarly, the PHY HT header 424 may be configured to send an HT CCA 426 to indicate a predetermined duration of the packet 400b. Similarly, the CF-End MPDU 428 may be configured to indicate termination of the NAV 416.

As with FIG. 3, the second PHY legacy header 420 may be interpreted by the access point 110 that new data is coming, and may thus effectively terminate the legacy CCA 404 for legacy devices. Similarly, the CF-End MPDU 428 may be configured to effectively terminate the NAV 416.

One should note that while the configuration of FIG. 4 includes sending certain header data to the access point 110, this is a nonlimiting example. More specifically, other data may be included in the headers of the first packet 400a and second packet 400b. Similarly, communications data may be included in the payload of the first packet and/or the second packet, depending on the particular exemplary embodiment.

FIG. 5 depicts an exemplary embodiment of a process that may be utilized in sending data, similar to the diagram from FIG. 4. As illustrated in the nonlimiting example of FIG. 5, the communications device 102 can create a PHY legacy header 402 with an indicated duration (legacy CCA 404) that extends beyond a second packet (block 532). The communications device 102 may create a PHY HT header 408 with an indicated duration (HT CCA 410) being directed at the end of first packet (block 534). The communications device 102 can create a CTS MPDU 414 for creating a NAV 416 that extends beyond the duration of the second packet (block 536). The communications device 102 can combine the created headers into the first packet 400a. The communications device 102 can send the first packet 400a (block 538).

The communications device 102 can create a PHY legacy header 420 with an indicated duration (legacy CCA) being directed to the end of a second packet (block 540). The communications device 102 can create a PHY HT header 424 with an indicated duration (HT CCA 426) directed to the end of the second packet (block 542). The communications device 102 can create a CF-End MPDU 428 indicating a predetermined duration at the end of the second packet (block 542). The communications device 102 can combine the headers into the second packet 400b and can send the second packet 400b (block 546).

FIG. 6 depicts an exemplary embodiment of a process that may be utilized in sending data in a communications network, similar to the diagram from FIG. 5. More specifically, as illustrated in the nonlimiting example of FIG. 6, a communications device 102 (and/or other communications device, such as access point 110) can send a first packet, the first packet including a first legacy physical layer header, the first legacy physical layer header including a first duration indication configured to indicate a predetermined duration, the predetermined duration being longer than an expected time for a second packet (block 632). The communications device 102 can also send the second packet, the second packet including a second legacy physical layer header, the second legacy physical layer header configured to provide a second duration indication substantially equal to a length of the second packet, the second legacy physical layer header further configured to reset an indication by the first legacy physical layer header (block 634). One should note that in at least one embodiment the second packet may be sent prior to expiration of the first duration.

The embodiments disclosed herein can be implemented in hardware, software, firmware, or a combination thereof. At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for resetting a signal, comprising:
sending a first packet, the first packet including a first legacy physical layer header, the first legacy physical layer header including a first duration indication configured to indicate a predetermined duration, the predetermined duration being longer than an expected time for a second packet; and
sending the second packet prior to expiration of the first duration indication, the second packet including a second legacy physical layer header, the second legacy physical layer header configured to provide a second duration indication substantially equal to a length of the second packet.

2. The method of claim 1, wherein the first legacy physical layer header is configured to create a first legacy clear channel assessment (CCA), wherein the second legacy physical layer header is configured to create a second legacy CCA, and wherein resetting an indication by the first legacy physical layer header includes resetting the first legacy CCA by the second legacy CCA.

3. The method of claim 1, wherein the first packet includes a first physical layer high throughput header, wherein the second packet includes a second physical layer high throughput header, and wherein the first physical layer high throughput header is configured to create a high throughput clear channel assessment (CCA) having a third duration substantially equal to a first packet duration, wherein the second physical layer high throughput header is configured to create a second high throughput CCA substantially equal to a fourth packet duration.

4. The method of claim 3, wherein the first packet includes a clear to send (CTS) media access control (MAC) protocol data unit (MPDU), the CTS MPDU configured to create a network allocation vector (NAV).

5. The method of claim 4, wherein the second packet includes a contention free end (CF-End) MPDU, the CF-End MPDU configured to reset the NAV created by the CTS MPDU at a predetermined time.

6. The method of claim 1, further comprising sending communication data in at least one of the following: the first packet and the second packet.

7. A system for resetting a signal, comprising:
a first sending component configured to send a first packet, the first packet including a first legacy physical layer header, the first legacy physical layer header including a first duration indication configured to indicate a predetermined duration, the predetermined duration being longer than an expected time for a second packet; and
a second sending component configured to send the second packet, the second packet including a second legacy physical layer header, the second legacy physical layer header configured to provide a second duration indication substantially equal to a length of the second packet, the second legacy physical layer header further configured to reset an indication by the first legacy physical layer header.

8. The system of claim 7, wherein the first legacy physical layer header is configured to create a first legacy clear channel assessment (CCA), wherein the second legacy physical layer header is configured to create a second legacy CCA, and wherein resetting an indication by the first legacy physical layer header includes resetting the first legacy CCA by the second legacy CCA.

9. The system of claim 7, wherein the first packet includes a first physical layer high throughput header, wherein the second packet includes a second physical layer high throughput header, and wherein the first physical layer high throughput header is configured to create a high throughput clear channel assessment (CCA) having a duration substantially equal to a first packet duration, wherein the second physical layer high throughput header is configured to create a second high throughput CCA substantially equal to a fourth packet duration.

10. The system of claim 9, wherein the first packet includes a clear to send (CTS) media access control (MAC) protocol data unit (MPDU), the CTS MPDU configured to create a network allocation vector (NAV).

11. The system of claim 10, wherein the second packet includes a contention free end (CF-End) MPDU, the CF-End MPDU configured to reset the NAV created by the CTS MPDU at a predetermined time.

12. The system of claim 7, further comprising a third sending component configured to send communication data in at least one of the following: the first packet and the second packet.

13. A computer readable medium for resetting a signal, comprising:
first sending logic configured to send a first packet, the first packet including a first legacy physical layer header, the first legacy physical layer header including a first duration indication configured to indicate a predetermined duration, the predetermined duration being longer than an expected time for a second packet; and
second sending logic configured to send the second packet, the second packet including a second legacy physical layer header, the second legacy physical layer header configured to provide a second duration indication substantially equal to a length of the second packet, the second legacy physical layer header further configured to reset an indication by the first legacy physical layer header.

14. The computer readable medium of claim 13, wherein the first legacy physical layer header is configured to create a first legacy clear channel assessment (CCA), wherein the second legacy physical layer header is configured to create a second legacy CCA, and wherein resetting an indication by the first legacy physical layer header includes resetting the first legacy CCA by the second legacy CCA.

15. The computer readable medium of claim 13, wherein the first packet includes a first physical layer high throughput header, wherein the second packet includes a second physical layer high throughput header, and wherein the first physical layer high throughput header is configured to create a high throughput clear channel assessment (CCA) having a duration substantially equal to a first packet duration, wherein the second physical layer high throughput header is configured to create a second high throughput CCA substantially equal to a fourth packet duration.

16. The computer readable medium of claim 15, wherein the first packet includes a clear to send (CTS) media access control (MAC) protocol data unit (MPDU), the CTS MPDU configured to create a network allocation vector (NAV).

17. The computer readable medium of claim 16, wherein the second packet includes a contention free end (CF-End) MPDU, the CF-End MPDU configured to reset the NAV created by the CTS MPDU at a predetermined time.

18. A method for resetting a signal, comprising:
sending a first packet, the first packet including a first legacy layer header; and
sending a second packet, the second packet including a second legacy physical layer header, the second legacy physical layer header configured to indicate a duration substantially equal to a length of the second packet, the legacy physical layer header further configured to reset an indication by the first legacy layer header.

19. The method of claim 18, wherein the second packet includes a physical layer high throughput header and a contention free end (CF-End) media access control (MAC) protocol data unit (MPDU), the CF-End MPDU configured to reset a network allocation vector (NAV).
